(19) United States
(12) Patent Application Publication
(10) Pub. No.: US 2007/0038596 A1
(43) Pub. Date: Feb. 15, 2007

(54) Restricting access to data based on data source rewriting

(75) Inventors: Michael J. Pizzo, Bothell, WA (US); Dempsey R. Swan, Woodinville, WA (US); Michael A. Uhlar, Sammamish, WA (US); Steven P. Anonsen, Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/203,922

(22) Filed: Aug. 15, 2005

(51) Int. Cl. G06F 17/30

(52) U.S. Cl. 707/2

(57) ABSTRACT

Data access is controlled by re-writing a data source, identified in an input query. The re-writing can be, for example, to a view or subquery or another data source, based on a variety of different criteria such as identity, role, group or other criteria.

### BACKGROUND

Current data storage systems often store a wide variety of sensitive data. Therefore, the owners of that data may desire access to the data to be restricted based on any number of different criteria. For instance, access to secure data may be restricted based on user identification, based on a user group, based on a user's role, etc. Enforcing permissions to access data has been undertaken in a number of different ways.

One way of restricting access to data is referred to as query re-writing. Often, the data is accessed through an interface in which a requesting client submits a query to a data accessing system (such as a database). The data accessing system executes the client's query against a data store and returns results from the query. In a system which uses conventional query re-writing to enforce permissions, the system augments or re-writes large portions of the query (or even the entire query), placing appropriate restrictions on it based upon the role of the client submitting the query, such that the client is not able to view data for which the client does not have the appropriate permission.

However, conventional query re-writing, because it involves re-writing large portions of the original query, has a number of significant disadvantages. It requires a relatively complete understanding of the syntax and semantics of the original query, so that when it is parsed, all the places in the query that are requesting unauthorized information can be identified and re-written or augmented. Such a system is also required to insure that the query is still valid even after it is re-written. A query re-writing system must also insure that the re-writing logic is not bypassed by the client by simply requesting information in a different part of the query, which is not normally re-written. These difficulties make the query re-writing solution a relatively complex, time-consuming and cumbersome solution to the problem of enforcing permissions.

Another way to enforce security permissions on data is to augment the data itself, such as by embedding in the data a mechanism used by the operating system to secure resources. One such mechanism uses Access Control Lists (ACLs). The ACLs authenticate a user request for the data based on the user ID. However, this is a highly inflexible system because each affected item of restricted data must be augmented, and modified, every time security permissions change. Such a system also makes it much more difficult to add new tables to the query, and in general requires queries of a greater degree of complexity.

Some mid-tier frameworks employ a middle tier between a client and a database system. The framework provides common services and components on top of lower level services. For example, an object-relational framework may expose objects whose properties are mapped to columns of tables within a relational database, accessed through a standard relational database interface.

In these types of mid-tier environments, the frameworks often expose custom security models in order to enforce permissions. The security models define users, groups, roles, etc. within the framework and assign permissions or behaviors to those “security identities”. The security identities can then be used consistently throughout the framework, which may aggregate lower level services with disparate identity models.

Examples of permissions include permissions to execute a piece of code, or permissions to read, create, or update data. Examples of identity-based behaviors include selection of columns to display in a grid based on a user's role, or different discount calculations based on a user's preferential status, etc.

In order to enforce data access permissions on security identities implemented by such a framework, those permissions must generally be expressed in a form that is meaningful within the data store being accessed. That form is generally not in terms of the data store's security permissions. For instance, in a mid-tier architecture, the framework generally uses a single authenticated identity to communicate with the data store and enforces permissions at the framework level in order to limit the data accessed by a security identity defined within the framework. In this type of environment, restriction of visible data is often enforced using the query re-writing approach. For example, in a relational database query, predicates are added to the “where” clause of the user's query in order to filter the result rows available, and the “select” list is restricted to project only those columns the security identity is allowed to view. Of course, these types of query re-writing must be performed on update, insert, and delete operations to restrict the data to that which the security identity is able to alter.

The level of understanding of the syntax and semantics of the query, in order to perform this type of query re-writing, is relatively high. For example, any existing “where”, “group by”, or “order by” clauses must be inspected to insure that they do not reference restricted columns. Sub-queries must be understood and correctly parsed and inspected, expressions must be parsed, etc. Therefore, the security enforcement code is generally tightly coupled with the query and update code. This results in a relatively restricted architecture that can be brittle and prone to errors and that could result in invalid queries or, worse, in unauthorized data access.

The discussion above is merely provided for general background information and is not intended to be used as an aid in determining the scope of the claimed subject matter.

### SUMMARY

Data access is controlled by re-writing a data source, identified in an input query. The data source can be re-written, for example, to a view or subquery or another data source, based on a variety of different criteria such as identify, role, group or other criteria.

The data source can be re-written during data source resolution. Of course, it can be re-written at other times as well.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter

### BRIEF DESCRIPTION OF THE DRAWINGS

FIG. 1 is a block diagram of one illustrative environment in which the present invention can be implemented.

FIG. 2 is a block diagram of a query transforming system in accordance with one embodiment of the invention.

FIGS. 3A and 3B illustrate a flow diagram showing the operation of the system shown in FIG. 2 in accordance with one embodiment of the invention.

FIG. 4 is a block diagram of another query transforming system in accordance with another embodiment of the invention.

### DETAILED DESCRIPTION

The present system deals with enforcing data access limitations using data source resolution. However, before describing the invention in more detail, one environment in which the present invention can be used will be described.

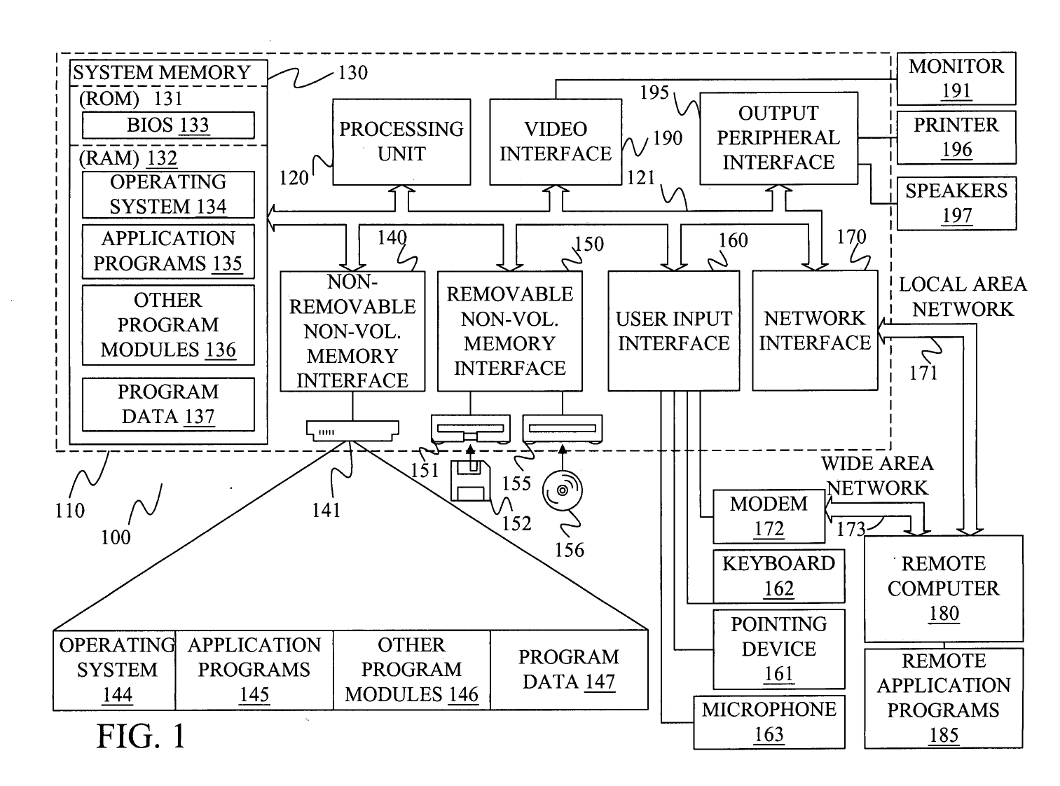

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

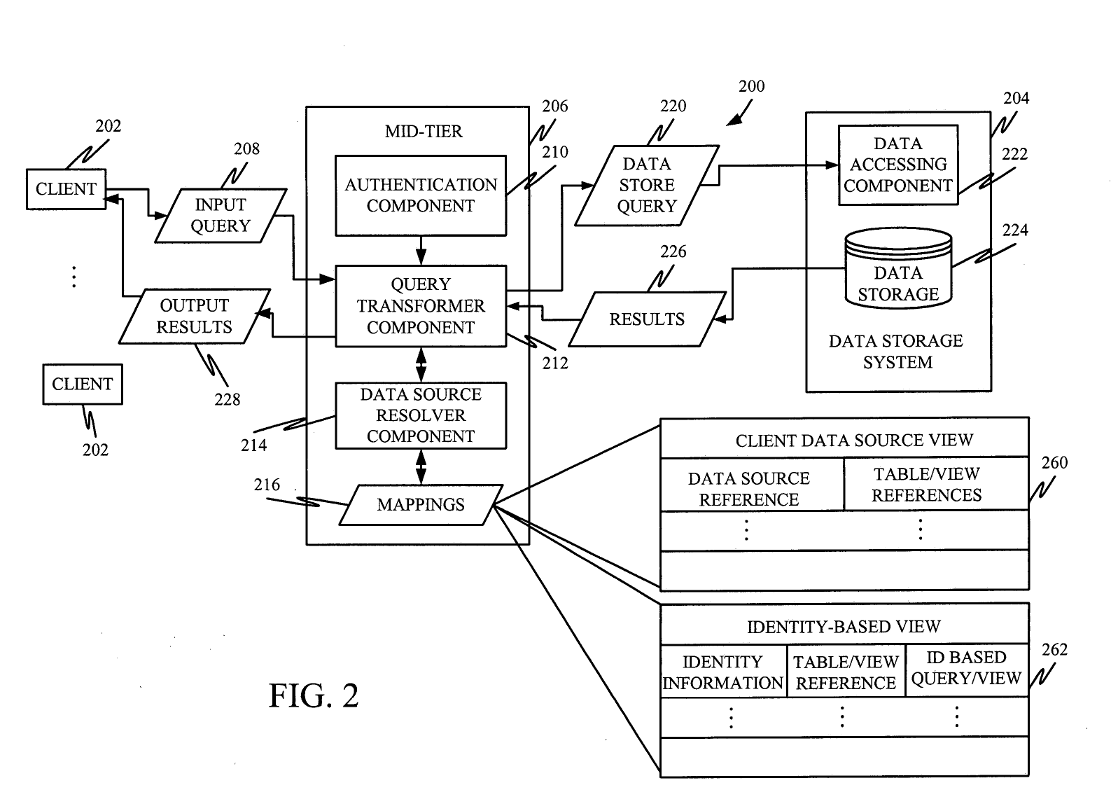

FIG. 2 shows a query transforming system 200 in accordance with one embodiment of the invention. System 200 shows that a plurality of clients 202 access data in a data storage system 204 through a mid-tier component 206. In one embodiment, clients 202 are users acting through computers, such as the one described with respect to FIG. 1. The users input a query 208 requesting data. In one illustrative embodiment, system 200 is an object-relational system in which clients 202 operate in an object-oriented environment and in which data is stored in data storage system 204 in a relational database environment. Of course, this is an exemplary system only and input queries and output results could alternatively be as relational records, XML, or other forms, for example. In any case, in this exemplary system, clients 202 provide input queries 208 in terms of objects.

Mid-tier component 206 includes an authentication component 210, query transformer component 212, and data source resolver component 214. Mid-tier 206 can also illustratively include object-relational mappings 216.

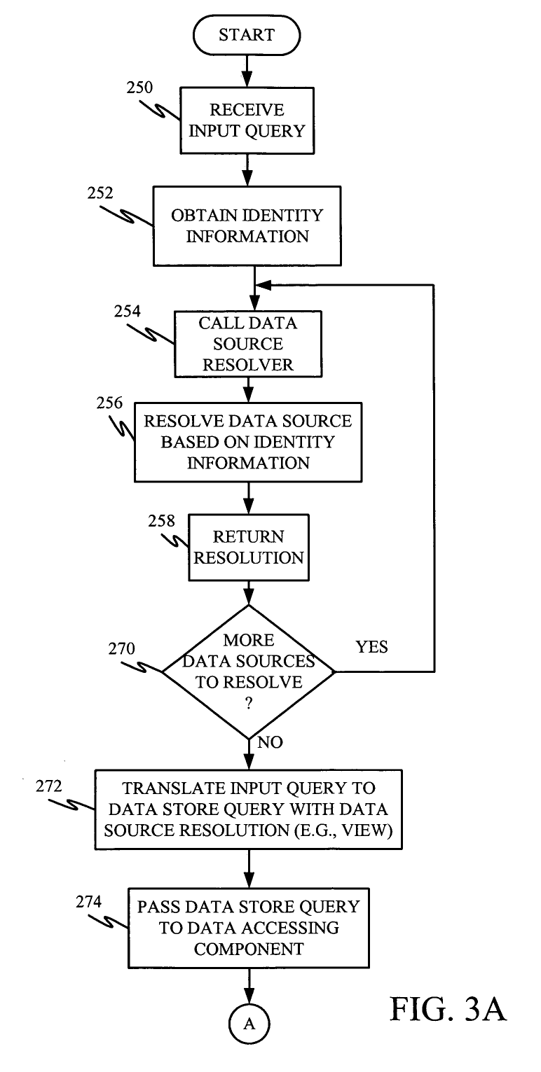

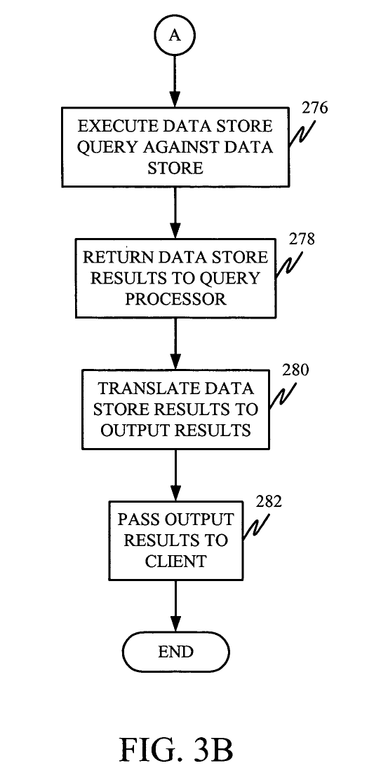

As will be described in greater detail below with respect to FIGS. 3A and 3B, query transformer component 212 receives input query 208 and translates it into a relational database query indicated by data store query 220 which is provided to data storage system 204. In the embodiment in which data storage system 204 is a relational database system, it may be a system which has a data accessing component 222 and a data store 224. For instance, data accessing component 222 can receive data store query 220 as a structured query language (SQL) query and executes the query against tables in relational data store 224. Data accessing component 222 provides results 226, which may illustratively be tabular data sets, back to mid-tier component 206. Query transformer 212, or other component in mid-tier component 206, translates results 226 into results specified in terms of objects, for example, and provides them, as output results 228, to the requesting client 202.

FIGS. 3A and 3B illustrate the operation system 200 in greater detail, and FIGS. 2, 3A and 3B will be discussed in conjunction with one another. First, client 202 provides input query 208, in the input language, to mid-tier 206, and specifically to query transformer component 212. Receiving the input query is indicated by block 250 in FIG. 3A. In the example being discussed, input query 208 is specified in terms of objects, because system 200 is an object-relational system. Of course, in other exemplary implementations, the input query 208 is provided in whatever language is used by client 202.

Query transformer 212 then obtains identity information from authentication component 210. In the embodiment being described, the data provided to client 202, which is requesting the data, is restricted based on the identity of client 202. Of course, it will be appreciated that in other embodiments the data can be restricted based on other criteria, such as the role that client 202 is in, the particular device client 202 is implemented on, or the bandwidth of the link between client 202 and mid-tier component 206, etc. In any case, in the present invention, the data is restricted based on the identity of client 202.

Therefore, at some point in the process, client 202 must provide its identity, and optionally other authentication information such as a password, to authentication component 210. Authentication component 210 then authenticates client 202 by comparing the client identity versus stored authentication information, and provides the authenticated identity to the query transformer component 212. Obtaining the identity information at query transformer component 212 is indicated by block 252 in FIG. 3A.

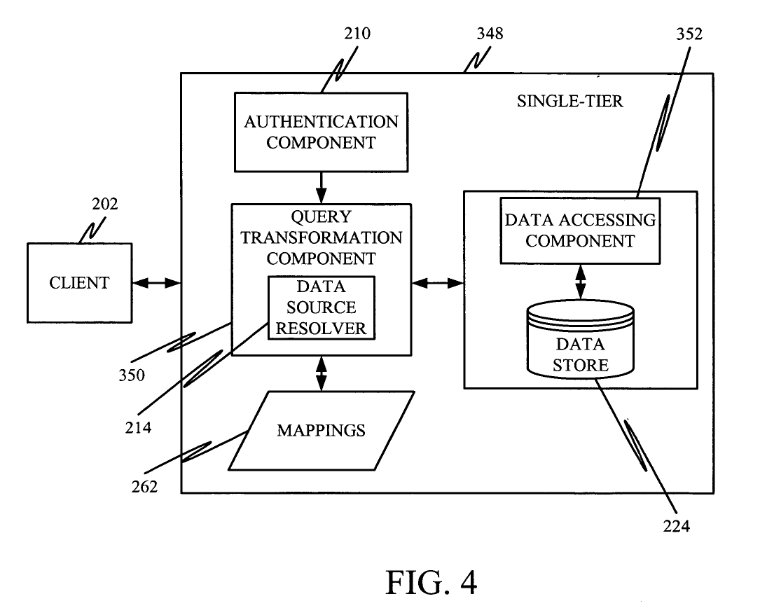

Query transformer component 212 then translates the input query 208 from the input language (such as from an object-oriented language) to the language used by data storage system 204 (as described below with respect to FIG. 4, the input language and that used by the data storage system can be the same in some embodiments). In the present example, data storage system 204 is a relational database and the information is accessed using the structured query language (SQL). Thus, data accessing component 222 in data storage system 204 is a SQL processor. Query transformer component 212 thus transforms input query 208 into a SQL query represented by data store query 220, and provides it to data accessing component 222 for execution against data store 224.

In order to make the transformation, in one embodiment, query transformer component 212, either itself, or through a separate data source resolver component 214, accesses mappings (for example, object-relational mappings) 216 which store a map that maps from representations in the space in which client 202 functions, into tables, columns and rows in the relational database space in which data storage system 204 operates. These mappings are used to generate a relational database query.

Of course, there are a wide variety of different ways in which this transformation can take place. For instance, query transformer component 212 can, itself, access mappings 216, to transform the entire input query 208 into the data store query 220. Alternatively, query transformer component 212 can call a map resolver to transform the query 208 into the data store query 220, wherein the map resolver is a separate component that accesses mappings 216 and returns the data store query. Alternatively, data source resolver component 214 can be used to resolve the data source of the query, or to transform the entire query.

In the embodiment discussed herein, it is assumed that query transformer component 212, as part of transforming the query input query 208, calls out to data source resolver component 214 with the data source to be resolved, along with identity information. Data source resolver component 214 returns the rewritten data source, which query transformer 212 uses to build data store query 220.

In an alternate embodiment, query transformer 212 calls out to data source resolver component 214 with only the data source to be resolved, and the data source resolver 214 directly calls the authentication component 210 in order to obtain the identity to use in resolving the data source.

In either case, in resolving the data source, data source resolver component 214 accesses mappings 216 which includes a client data source to relational map 260 (for example, a mapping between object types and relational tables or views). The client data source to relational map 260 illustratively is a table that is stored in metadata, that stores client data sources and corresponding relational tables or views. This maps the data sources referred to by client 202 and input query 208, to locations in the relational database system 204 and specifically the tables and rows containing the data in data store 224. One exemplary transformed query is shown as follows:
Select x, y, z from Alphabet Where (x>y and z=23) Eq. 1

The query includes a “select” statement, a “from” statement, and a “where” statement. The “select” statement identifies particular fields of interest in tables in a relational database. The “from” clause identifies the particular tables from which the data is to be retrieved, and the “where” clause parameterizes those particular fields desired. Therefore, the “select” statement identifies a set of fields in a table identified in the “from” statement, and the particular individual fields (the table entries) to be accessed are identified in the “where” statement.

In some prior query re-writing systems, in order to restrict access to a given role, at least the “where” clause would be re-written to limit the specific table entries returned, to only those to which the client role is allowed access. However, the query re-writing logic would then also need to parse the “select” clause to insure that the client has not specified anything in that clause for which they are not allowed access. This was often a very complicated recursive process. For instance, every time the “where” clause was re-written, the “select” clause would need to be re-evaluated, and vice versa to insure that no access-limited data was being provided to the particular client requesting the data. This has made such systems very cumbersome.

One embodiment of the invention uses the data source of a query as the point where specialized logic can be plugged in and used to enforce authorization and other identity-based constraints (or any other data accessing constraints). In other words, no matter what type of data storage system 204 is used, the target data source of the query (i.e., the data source from which information is to be retrieved) is identifiable within the query. In accordance with one embodiment of the invention, this target data source (also sometimes referred to as the extent of the query) is re-written or replaced in a manner that yields the appropriately restricted subset of data. In one embodiment described herein, re-writing the data source is done during the resolution of the data resource, but it could be done at any other desired time as well by another data source processing component, other than data source resolver component 214. In the present example, the “from” clause identifies the data source of the query, and this clause is used to enforce permissions.

In one illustrative embodiment, mappings 216 are defined in metadata and not only include table 260 in metadata (discussed above) but further include an identity-based view map 262. The identity-based view map 262 allows data source resolver 214 to use the relational table or view obtained from metadata 260 to look up in identity-based view map 262 a stored view or query based upon the identity information provided to it, for example, by query transformer component 212. Alternatively, data source resolver component 214 could combine metadata 260 and identity-based view 262 into a single mapping table indexed by both client data source and identity that returned a stored view or query based on the identity information. In either case, while data source resolver component 214 is resolving the data source of the query (such as the table “Alphabet” in the query shown in Equation 1), it also accesses identity-based view map 262 and obtains the appropriate identity-mapped view based on the identity information corresponding to the client 202 submitting the query. Because the “from” clause is the first clause evaluated in executing the query, it defines the total data set which is available to the rest of the query (i.e., to the “select” and “where” clauses). Therefore, anything that is not exposed in the data source (the “from” clause) is not exposed through the submitted query. Calling the data source resolver and resolving (including re-writing) the data source based on authentication information is indicated by blocks 254 and 256 in FIG. 3A.

In accordance with one embodiment, the stored views in permissions map 262 can include filters (e.g. “where” clauses) or projections (e.g. “select” lists), as appropriate, based upon the security identity, such that unauthorized rows or restricted columns are not visible to the rest of the client's query. In the embodiment being discussed, the data is filtered by replacing the data source, “Alphabet” with an arbitrarily complex sub-query. In making this replacement, data source resolver component 214 might, in the embodiment being discussed, return a sub-query such as that identified in the “from” clause in the following example:
Select x, y, z from (select a.a. as x, a.b as y, a.zed as z from Alphabet_Table a join user_table u where a.category=u.Category) Where (x>y and z=23) Eq. 2

It can be seen that the new sub-query in the “from” clause includes an inner select that can be arbitrarily complex, without affecting the outer select in any way. The specific syntax used in this example, of course, is not important, and different frameworks will likely have different mechanisms for specifying the sub-query. However, it will be specifically noted that, rather than merging an inner and outer select into a single query, they are each individually composed. Thus, whatever mechanism is used for replacing or augmenting the data source, it supports composable queries of the type shown. Returning the data source resolution is indicated by block 258 in FIG. 3A.

Of course, it may happen that the sub-query (such as the “from” clause specified in Equation 2 above) may change the data source of the query to require further resolution. Therefore, query transformer component 212 determines whether there are any more data sources which need to be resolved. This is indicated by block 270 in FIG. 3A. If so, processing reverts to block 254 where query transformer component 212 again calls data source resolver component 214 to further resolve the data source. The further resolution may again result in re-writing the data source of the subquery. Therefore, this process is recursive and data source resolution continues until the entire query is fully resolved with respect to data source.

Once the data source has been fully resolved, then query transformer component 212 can continue processing the data store query with the appropriate data source resolution (or view). This is indicated by block 272 in FIG. 3A. The data store query is then provided to data accessing component 222. Passing data store query 220 to data accessing component 222 in data system 204 is indicated by block 274 in FIG. 3A.

Data accessing component 222 then executes the data store query 220 against the relational data in data store 224. This is indicated by block 276 in FIG. 3B. Data accessing component 222 then returns results 226 to query transformer component 212. This is indicated by block 278 in FIG. 3B. Query transformer component 212 then translates the results 226 into output results 228. In the example being discussed, the results 226 are provided in tabular form from data storage system 204, and they are converted into objects in output results 228, by query transformer component 212. However, this is exemplary only and other results might be requested as well. For instance, the query may be requesting only a few properties of an object and not the entire object, in which case the data may not be returned in an object, or it could be returned in a different object. Outputting the results is indicated by block 280 in FIG. 3B.

It will be noted, of course, that the translation of results 226 into results 228 expected by client 202 can be performed by a different component, other than query transformer component 212. Having query transformer component 212 both process the input query 208 and the returned results 226 is only one exemplary implementation. These functions can be separated as desired.

In any case, mid-tier component 206 then provides output results 228, in the form expected by client 202, to client 202. This is indicated by block 282 in FIG. 3B.

Because enforcement of permissions is localized to the data source re-writing step (which can take place during resolution) and without changing the rest of the query, the details, syntax and semantics of the remainder of the query do not need to be understood by, or in anyway parsed by, a security component. This makes the system quite simple to implement.

In addition, the data source resolver component 214 that re-writes the data source can be a pluggable component of the framework of the system 200 shown in FIG. 2. The pluggable component, of course, will vary based on what type of data storage system 204 is being used, and different components can be provided to implement different security strategies. The pluggable resolver component 214 simply provides queries or views based on security identity.

Because the data source resolution component is separate from the query transformer component, they do not need to have detailed knowledge about one another. Also, the mappings can be stored in any desired form, and only need to be understood by the data source resolver component 214.

In addition, because data source resolver component 214 is pluggable, different resolver logic can easily be plugged into system 200. For instance, in a very simple embodiment, the mappings may simply be stored in an XML file that identifies which views certain security identities are permitted to view. Of course, in a more complex environment in which more data exists, an XML file specifying allowed views may not be reasonable. In that case, data source resolver component 214 might be a metadata server and associated database with an identity-view data store in which views are retrieved and transactionally applied to queries. Similarly, the mappings could be a series of joins, or any other type of clauses desired by the designer of the data source resolver component 214.

FIG. 4 illustrates another embodiment in which the invention can be used. A number of items are similar to those shown in FIG. 2, and are similarly numbered. However, instead of having a mid-tier component 206, FIG. 4 shows the invention used in a single tier environment 348. In that environment, the data accessing component 352 may simply be a disc drive controller that accesses data stored on a drive 224. In addition, the query transformer component 350 shown in FIG. 4 has data source resolver 214 integrated therein. It will be noted that data source resolver 214 can be integrated in query transformer component 350 regardless of whether it is implemented in a single-tier, or mid-tier system. However, it is shown integrated in FIG. 4 for the sake of example.

In addition, in the example shown in FIG. 4, the single-tier system does not require a translation from the language used by client 202 to the language used by data accessing component 352. In this case, there may still be mapping information to transform results from one shape to another within the same language or the mappings might only include the identity-based view map 262. Thus, data source resolver 214 receives the input query from client 202 and simply resolves the data source by placing permitted views in the data source clause in the input query, thus restricting the data available to the client 202 based on the client's identity or other authentication information.

It can thus be seen, with the present invention, it is very easy to prove that no restricted data was provided to a client who is not supposed to have access to that data. By examining the views permitted to a given client, it can quickly be determined what data that client has access to, without going through the entire process of re-writing a query and checking the results of the re-write.

It will also be appreciated that authentication component 210 can be pluggable and provide whatever type of authentication information the developer of the system desires. It simply needs to provide authentication information in the form expected by data source resolver component 214. The authorization information can be directly requested by data source resolver component 214 or by query transformer component 212, as desired.

In addition, data source resolver component 214 can, in one embodiment, determine the security identity of client 202 itself. In that case, the functionality of authentication component 210 might be integrated with data source resolver component 214, or at least enough of that functionality in order for data source resolver component 214 to identify the security identity submitting the query.

It will also be noted that, while the present discussion has proceeded with respect to resolving data source based on identity or other authentication information, the data source could be re-written and resolved based on substantially any other type of information as well. For instance, if client 202 is a mobile device, such as a personal digital assistant (PDA) or a cellular telephone, the views desired by the user of client 202 may be much smaller than those where client 202 is a desktop computer, for instance. In that case, query transformer 212 can receive a device identifier identifying the particular type of device which is implementing client 202, and hand the device identifier to data source resolver 214, which re-writes the data source of the query based upon the device identity. This can, of course, be implemented in addition to the security-based permissions such that the re-written data source reflects restrictions based not only on the identity of the device, but the identity of the user as well.

Similarly, the present invention can limit access to data based on the role of client 202, instead of the identity of the user. It could also limit data access based upon the type of application being run on client 202. In that case, the application ID is simply made available to data source resolver component 214, and the views returned as the re-written data source are selected based upon the application ID, either by itself or in addition to other information. Any other desirable criteria can be used as well. Those given are only exemplary. In any of these cases, the mappings 216 simply include mappings between whatever criteria are being used to limit views and the particular views or storage structures in data storage system 204 that store data in those views.

It will also be noted that the particular mechanism used by data source resolver component 214 in order to re-write and resolve the data source is not limited to those discussed herein. Data source resolver 214 can resolve the data source by accessing tables, loading from an XML document, dynamically building and returning the view, referencing objects in memory, substituting other queries, by executing additional queries to obtain the ultimately resolved view, etc. Similarly, the format of what data source resolver component 214 receives from query transformer component 212 can take any of a wide variety of different forms and will illustratively simply be provided in a form expected by data source resolver component 214. The form might include, for example, a string, a tree structure, or any other expression. The format of the identity information passed to the data source resolver component 214, whether by the query transformer component 212 or the authentication component 210, can also take a wide variety of forms, for instance as a string, a security token, a structure, or other form that can be used by the data source resolver component 214 to look up the appropriate mapping. The content of the data source provided from data source resolver component 213 to query transformer component 212 can also take any of a wide variety of different forms, such as a string, a tree structure, a dynamically formed query, a query against a view, a table valued function, etc.

The present system can also be used to direct queries to different source tables based on the user identity or other criteria. For instance, where sales data is particularly partitioned into different tables based on region, the query for a particular manager can be directed to the appropriate table containing sales data for that manager's region only. The present invention can of course enforce column-wise permissions in the database or row-wise permissions, or both.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A data accessing system, comprising:
a data source processing component configured to receive information indicative of a characteristic of a requester requesting data, and to re-write a data source identified in an input query from the requester to restrict the data source, available through the query, based on the characteristic of the requester.

2. The data accessing system of claim 1 wherein the information indicative of a characteristic of the requester comprises identity information indicative of an identity of the requester and wherein the data source processing component is configured to re-write the source in the input query based on the identity of the requester.

3. The data accessing system of claim 1 wherein the information indicative of a characteristic of the requester comprises role information indicative of a role of the requester and wherein the data source processing component is configured to re-write the source in the input query based on the role of the requester.

4. The data accessing system of claim 1 wherein the information indicative of a characteristic of the requester comprises group information indicative of a group to which the requester belongs and wherein the data source processing component is configured to re-write the source in the input query based on the group.

5. The data accessing system of claim 1 wherein the information indicative of a characteristic of the requester comprises requester device information indicative of a characteristic of the device used by the requester and wherein the data source processing component is configured to re-write the source in the input query based on the characteristic of the device.

6. The data accessing system of claim 1 wherein the data source processing component is configured to re-write the data source to restrict the source to enforce security permissions to access the data.

7. The data accessing system of claim 1 wherein the data source comprises a relational data store in which data is stored in rows and columns in tables and wherein the data source processing component is configured to perform row-wise restriction of the data source.

8. The data accessing system of claim 1 wherein the data source comprises a relational data store in which data is stored in rows and columns in tables and wherein the data source processing component is configured to perform column-wise restriction of the data source.

9. The data accessing system of claim 1 wherein the data source comprises a relational data store in which data is stored in rows and columns in tables and wherein the data source processing component is configured to direct the query to a set of tables based on the characteristic of the requester.

10. The data accessing system of claim 1 wherein the data source processing component is configured to re-write the data source to a subquery.

11. The data accessing system of claim 1 wherein the data source processing component is configured to resolve the data source to a view mapped to the characteristic of the requester.

12. The data accessing system of claim 2 wherein the data source processsing component is configured to determine the identity information.

13. The data accessing system of claim 2 wherein the data source processing component is configured to receive the identity information from another component.

14. The data accessing system of claim 1 and further comprising:
a query transforming component configured to translate the query from an object-based query to a relational database query.

15. The data accessing component of claim 14 wherein the data source processing component is separate from the query transforming component and interchangeable with other data source processing components in connection with the query transforming component.

16. The data accessing component of claim 14 wherein the data source processing component is integral with the query transforming component.

17. The data accessing component of claim 14 wherein the query transforming component and the data source processing component interact to recursively resolve the data source.

18. The data accessing component of claim 1 wherein the data source processing component further comprises a data source resolution component that resolves the data source.

19. A method of controlling access to data in a data store, comprising:
receiving a query, identifying a data source, for data from a requester;
obtaining identity information corresponding to the requester;
re-writing the data source in the query based on the identity information; and
executing the query, with the re-written data source, against the data store.

20. The method of claim 19 wherein re-writing the data source comprises:
resolving the data source to a view of the data allowed based on the identity information, or to a subquery within the query.
